(19) United States
(12) Patent Application Publication
(10) Pub. No.: US 2003/0037341 A1
(43) Pub. Date: Feb. 20, 2003

(54) System for remotely controlling consumer electronics using a web-cam image

(76) Inventor: Pieter Sierd Van Der Meulen, Sunnyvale, CA (US)

Correspondence Address: U.S. Philips Corporation, 580 White Plains Road, Tarrytown, NY, 10591, US

(21) Appl. No.: 09/932,105

(22) Filed: Aug. 17, 2001

(51) Int. Cl. H04N 7/173; H04N 7/16

(52) U.S. Cl. 725/143; 725/135; 725/105

(57) ABSTRACT

A system is provided which uses a camera to generate an image of an environment to be controlled by the user. The image is displayed on a display monitor of a control device. The control device allows the user to interact with a region of the image on the display monitor. The region corresponds to controllable consumer electronics (CE) equipment displayed within the image of the environment. Interaction with the region causes the CE equipment to be controlled in a pre-programmed manner.

### BACKGROUND OF THE INVENTION

1. Field of the invention

The invention relates to, among other things, remote control of consumer electronics (CE) equipment.

2. Disclosure of the Related Art

Remote control units are widely known. An example is the Pronto TM manufactured by Royal Philips Electronics. The Pronto™ is a so-called universal programmable remote control unit for control of CE equipment via IR. It enables storing the IR codes of practically any existing consumer electronics (CE) apparatus. The Pronto™ has an LCD with touch screen functionality as a graphical user-interface (GUI). The control functionalities of the Pronto TM can be fully customized by the user him/herself. The individual control functionalities are graphically represented as icons. The Pronto™ allows the user to cluster respective groups of icons in respective pages that can be retrieved and displayed on the touch screen LCD.

### SUMMARY OF THE INVENTION

The invention uses a camera to generate an image of an environment to be controlled by the user. The image is displayed on a display monitor of a control device. The control device allows the user to interact with a region of the image on the display monitor. The region corresponds to controllable consumer electronics (CE) equipment displayed within the image of the environment. Interaction with the region causes the CE equipment to be controlled in a pre-programmed manner.

The invention uses, for example, a web-cam, i.e., a video camera that is coupled to a web-server, to allow the user to remotely watch what the camera is capturing, e.g., live video or a still picture. The image captured by the web-cam can be transferred via the web-server and the Internet or another data network to a set-top box or personal computer having a web browser.

To associate the two-dimensional coordinates of the image captured from the camera with the CE equipment that can be controlled, a training mode is used. For example, by turning a lamp on and off several times, the system of the present invention learns which pixels in the captured image are associated with the lamp and uses that information to construct an image map.

As an example, wherein the system of the present invention is being used in a home environment, the user remotely controls the web-cam to capture an image of a portion of his/her controllable home equipment. The home equipment comprises, e.g., lamps, a sprinkler installation, a coffee machine, an in-house climate control apparatus, etc. The captured image is displayed on a display screen of a control device interacted with by the user. The region in the image displaying a specific piece of the equipment represents an active region assigned to controlling this specific piece of equipment. When the user activates this image region on the control device, e.g., via a touch screen or by positioning a cursor within the region and clicking a computer mouse, a command is generated that is sent from the control device to the relevant piece of equipment.

An embodiment of the invention provides an information processing system that has a handheld computing device, e.g., a PDA (Personal Digital Assistant), with a graphical user-interface (GUI) and a wireless modem coupled to the handheld device. The wireless modem enables communication with a server via a data network such as the Internet. A control network is coupled between the server and controllable equipment. The handheld device is capable of functioning as a wireless remote control device for the equipment via the Internet and the server. The system also includes a video camera, e.g., a web-cam, together with hardware and software to create a formatted still image suitable for being displayed on the PDA's LCD screen.

The image serves as the graphical user-interface of the handheld device. The displayed web-cam image or regions thereof can be clicked or touched to effect a command to be sent for remotely controlling CE or other electronic devices displayed within the web-cam's image. For example, the user can touch an image of a lamp on a web-cam image to instruct the server to execute a program to remotely send commands to the lamp to turn it on or off. If the lamp is in the video camera's range of view, the lamp switching on or off can be visually verified via the real-time web-cam video image.

Incorporated herein by reference are the following patent documents:

U.S. application Ser. No. 09/427,821 filed on Oct. 27, 1999 for Joost Kemink and Rik Sagar for PDA HAS WIRELESS MODEM FOR REMOTE CONTROL VIA THE INTERNET. This document relates to a combination of a PDA and a wireless modem to enable remote control of CE equipment via the Internet and a local home server.

U.S. application Ser. No. 09/544,666 filed on Apr. 6, 2000 for Rik Sagar for HANDHELD RETRIEVES UI FROM SERVER FOR CONTROL OF APPARATUS VIA SERVER. This document relates to a handheld remote that has a wireless modem to send an identifier to a server on the Internet.

The server has a look-up table to associate the identifier with a URL. The URL specifies a CGI program on another machine on the Internet. The machine controls equipment through execution of the CGI program.

U.S. application Ser. No. 09/434,155 filed on Nov. 4, 1999 for Martin Freeman and Bonghan Cho for REMOTE INITIATES RETRIEVAL OF CONTROL CONFIGURATION. This document relates to a programmable remote control unit that is capable of initiating retrieval of a control configuration from a storage device external to the unit. The unit includes a memory to store the retrieved control configuration; a display for display of icons representing the configuration; and a touch screen for entering a selection based on the icons displayed. The storage device is a component a CE apparatus. By storing or backing-up the control configuration for a specific apparatus in the apparatus itself the remote is made truly universally programmable.

U.S. application Ser. No. 09/160,490 filed on Sep. 25, 1998 for Adrian Turner, Simon Pearce, David Eves and Allan Timms for CUSTOMIZED UPGRADING OF INTERNET-ENABLED DEVICES BASED ON USER-PROFILE, and U.S. Serial No. 09/189,535 filed on Nov. 10, 1998 for Eugene Shteyn for UPGRADING OF SYNERGETIC ASPECTS OF HOME NETWORKS, both of which relate to a server system that maintains a user profile of a particular end-user of consumer electronics network-enabled equipment and a data base of new technical features for this type of equipment. If there is a match between the profile and a new technical feature, and the user has indicated he/she is willing to receive the information about updates or sales offers, the user gets notified via the network of the option to obtain the feature. Synergy is detected between pieces of equipment of the user in order to notify him/her of further possibilities of using or expanding his/her equipment.

### BRIEF DESCRIPTION OF THE DRAWINGS

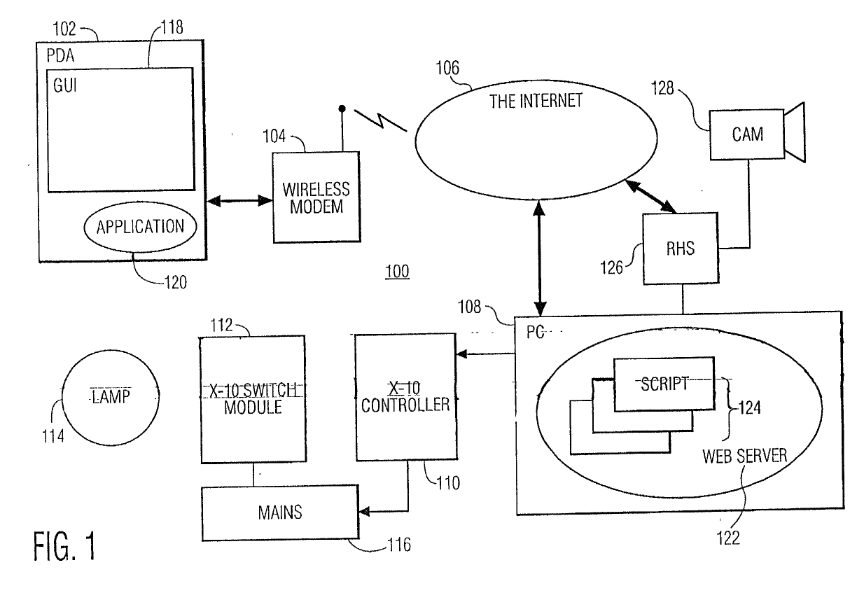

The invention is explained by way of example and with reference to the accompanying drawings, wherein FIG. 1 is a block diagram of a system according to the invention.

### DETAILED DESCRIPTION OF THE PREFERRED EMBODIMENTS

The invention is explained below within the context of two examples. A first example is the use of the remote control via the Internet to turn on and turn off a lamp. The second example relates to retrieving a stored image from a home server.

FIG. 1 is a block diagram of a system 100 of the invention. System 100 includes a hand-held device 102 such as a personal digital assistant (PDA) ,e.g., a PalmIIIx manufactured by 3COM or a Windows CE™-based handheld, that is connected to a data network 106, e.g., the Internet, via a wireless modem 104. Modem 104 is, for example, a Minstrel or a Ricochet. The Minstrel marketed by Novatel Wireless is a two-way wireless modem for a PDA that lets the user browse the Web and receive e-mail, among other things.

In a more general sense, a wireless modem like the Minstrel or Ricochet provides the handheld device 102 with an IP address that can be used by any type of application that uses the Internet for communication (within limitations of throughput, latency and coverage). The Minstrel uses a technology referred to as Cellular Digital Packet Data (CDPD) that is supported by the cellular service providers. Web surfing is limited to a CDPD speed cap of 19.2 kbps.

The Ricochet from Metricom has a faster connect rate, in the 28.8 kbps range, but it is supported in only three metropolitan centers (the San Francisco Bay area, Seattle and Washington). The remote control functionality in the system of the invention does not require a high data rate. The information communicated is limited in size. The data rate in this example is approximately 9,600 Baud.

It is contemplated that the hand-held device 102 could be a device other than a PDA. For example, it is envisioned that the hand-held device 102 could be a device capable of emitting RF signals or a personal computer directly connected (i.e., non-wirelessly) to a data network, such as the Internet.

System 100 further has a server 108, an X-10 controller 110, an X-10 switch module 112 and a lamp 114. X-10 is a communications protocol for control of electrical devices. The protocol is designed for communications between X-10 transmitters and X-10 receivers which communicate on standard household wiring 116. X-10 is mentioned here as an example. Alternative control mechanisms are feasible that do not use the power supply lines, such as CEBus, 12C, IR (through an IR blaster), etc. Switch 112 connects lamp 114 to mains power supply 116 under control of controller 110. Controller 110 in turn gets its control input from server 108.

PDA 102 has a display or graphical user-interface (GUI) 118 with a touch screen or graphical tablet functionality, and a client application 120. Client application 120 controls the creation of soft buttons on display 118.

When a user activates an ON button on display 118, application 120 uses wireless modem 104 to send a command via the Internet 106 to server 108. Server 108 includes a PC hardware running a web server 122 and software modules 124 that include CGI scripts run by the web server 122. CGI stands for Common Gateway Interface and is part of the HTTP protocol. CGI is used to transfer information back and forth between the web server 122 and an application, such as client application 120.

The web server 122 running on PC 108 interprets the command received from the PDA 102 over the Internet 106. The interpretation mechanism uses, e.g., a database on PC 108, wherein each specific command received is linked to a specific action. The database can be fully customized by the user. The command in this example is interpreted as an action to turn lamp 114 on.

To this end, PC 108 communicates with controller 110, e.g., via an RS232 cable, and instructs the latter to issue a command to switch 112 to turn lamp 114 on. Switch 112 receives the command and connects lamp 114 with power lines 116. Similarly, when the user thereafter presses an OFF-button on display 118, client application 120 sends a corresponding command via modem 104 to PC 108 via the Internet 106. The web server 122 interprets the command and instructs controller 110 to let switch 112 turn off lamp 114.

System 100 further includes a server 126, herein referred to as the Reliable Home Server (RHS), and a video camera 128, such as a web-cam. RHS 126 may be a component within server 122 or a separate low-cost server, as in this example. Alternatively, web server 122 and scripts 124 can be components of server 126.

The video camera 128 allows the user to remotely watch what the video camera 128 is capturing, e.g., live video or a still picture which can be automatically refreshed.

RHS 126 includes hardware and software to receive images from at least one video source, in this example, a video image from the video camera 128, and transfer the images to the PDA 102 or another computer with a web browser. Client application 120 provides a soft button, e.g., VIEW, that, when pressed, lets application 120 send a command via the modem 104 and the Internet 106 to the server 108. The web server 122 running on PC 108 receives the command, interprets it and instructs RHS 126 to transmit the video image to the web server 122. The latter converts the format of the video image suitable for display on GUI 118 of PDA 102 and then stores the formatted image in a database within a memory of PC 108.

The user presses another soft button, e.g., IMAGE, created by client application 120. The associated command gets sent via the modem 104 and the Internet 106 to the PC 108. The web server 122 receives the command, interprets it, and accordingly retrieves the stored image from the database and returns it to PDA 102 via common Internet protocols. PDA 102 then displays the image on GUI 118 under control of client application 120.

The image displayed by the GUI 118 can be clicked or touched to effect a clickable user-interface (image-map) to remotely control the lamp 114 and other electronic devices. For example, the user can touch an image of the lamp 114 on the image to instruct the web server 122 to execute a program to remotely send on/off commands to the lamp 114. If the lamp 114 is network-enabled (e.g., Internet-enabled), the lamp 114 can be controlled directly via its own Internet address and web server 122. If the lamp 114 is not network-enabled, the lamp 114 can be coupled to RHS 126 through which it is indirectly controllable.

It is contemplated for RHS 126 to give conditional access, e.g., through a password, for security purposes. It is further contemplated to also control the lamp 114 by touching a real-time web-cam video image which is periodically refreshed and displayed by the GUI 118. Accordingly, if the lamp 114 is in the video camera's range of view, the lamp 114 switching on or off can be visually verified via the real-time web-cam video image, i.e., the lamp 114 being turned on or off affects the colors or brightness of the image. In other examples, the presence or absence of a water jet confirms whether a sprinkler is turned on or off. An “on” light at the coffee machine or the heater confirms an power-on mode.

Alternatively, a user-interface, such as a slider control panel, could pop up if an image of a device on the web-cam video image is clicked or touched. For example, the user can touch an image of a radio on a web-cam video image to pop up a slider control panel having various control options, such as turning the radio on, adjusting the volume, playing a cassette, etc. Upon touching one or more of the various control options, the web server 122 is instructed to execute a program to remotely control the radio accordingly. Thus, the image of the apparatus to be controlled, as captured by the video camera 128, serves as part of an intuitive user-interface.

To associate the two-dimensional coordinates of the video image captured from the video camera 128 with the CE and appliances that can be controlled, a training mode is used. For example, by turning the lamp 114 on and off several times, the system learns which pixels in the captured video image are associated with the lamp 114 and uses that information to construct an image map.

It is also envisioned to train the system of the present invention to associate certain tasks, e.g., individual control commands, with images or regions thereof. The image or a region thereof thus serves to represent a command at the user-interface. The images can be captured during the training session(s) and saved for future use. During use, the user is presented with images or other pre-defined representations (e.g., icons) that reflect different states of the equipment to be controlled. The user chooses or effects the equipment's state reflected by the chosen image by means of, e.g., clicking on the chosen image or performing another confirming action.

Further, the system of the present invention enables the user to create a representation of the desired state of the equipment to be controlled by highlighting icons or by using a drag-and-drop icon interface, where each icon represents an effect, e.g., light on/off. An image of a real environment (room, theater stage, etc.) can be used as the background to make the system easier to use. The system is trained to associate the state of an apparatus to be controlled with the particular element or icon being highlighted or dragged-and dropped.

Alternatively, drag-and-drop icons can have attributes associated with their effects, so they can be placed into spaces that satisfy those attributes. For example, an icon of a light or lamp can be associated with the particular coordinates of the area that a lamp illuminates. If the icon of the light or lamp is placed in the particular coordinates of the drag-and-drop interface, then the lamp is turned on. When the icon is removed from the particular coordinates, then the lamp is turned off.

The remote control system of the present invention has been explained with reference to some conceptually simple examples. It is clear that other and more sophisticated scenarios can be implemented using the invention. For example, a recording device such as a VCR or TiVo can be programmed from anywhere in the world when the user realizes that he/she has forgotten or was unable to set the device to record a favorite TV program. Within this context, also see U.S. Serial No. 09/283,545 (attorney docket PHA 23,633) filed Apr. 1, 1999 for Eugene Shteyn for TIME-AND LOCATION-DRIVEN PERSONALIZED TV, the contents of which are incorporated herein by reference. As another example, the user may turn on the central heating and turn on the lights at home and in the garden while returning home by car late at night. As another example, the user may program or activate the sprinkler installation in the garden at home while at work or while traveling.

The system of the present invention is also envisioned to serve as a security system that enables a remote user to monitor his/her home, or as a fall-back baby-sit system that enables a parent to monitor a child in a different location.

Accordingly, what has been described herein is merely illustrative of the application of the principles of the present invention. Hence, other arrangements and methods may be implemented by those skilled in the art without departing from the scope and spirit of this invention.

What is claimed is:

1. An information processing system, comprising:
a camera for capturing an image of controllable equipment;
a server coupled to the camera and to a data network;
an apparatus for receiving the image from the server via the network and comprising:
a display monitor for displaying the image; and
a control interface that associates the image with a command for control of the controllable equipment upon a user-interaction with the control interface.

2. The system of claim 1, wherein the control interface associates respective regions of the image with respective commands for control of the controllable equipment upon the user-interaction with the respective region.

3. The system of claim 1, wherein the control interface comprises a touch screen.

4. The system of claim 1, wherein the control interface comprises a computer mouse.

5. The system of claim 1, wherein the control interface comprises controls for controlling the camera.

6. The system of claim 1, wherein the equipment is controllable via the server.

7. The system of claim 2, wherein the apparatus comprises software for configuring the associating of the respective regions with the respective commands.

8. A method for enabling a user to remotely control equipment, the method comprising:
capturing an image of the equipment via a camera coupled to a server;
retrieving the image from the server via a data network;
displaying the image on a display monitor; and
enabling the user to interact with a control interface that associates the image with a command for control of the equipment upon a user-interaction with the control interface.

9. The method of claim 8, further comprising the steps of:
enabling the user to control a plurality of controllable entities of the equipment;
associating a respective region of the image with a respective command for control of a respective one of the plurality of controllable entities; and
enabling the user to interact with the respective region for effecting the control of the respective one of the plurality of controllable entities.

10. A remote control system for remotely controlling equipment, the device comprising:
a camera for capturing an image of the equipment;
a data input for receiving, via a network, data representing the image of the equipment;
a display monitor for display of the image; and
a control interface for associating the image with a command for control of the equipment upon a user-interaction with the control interface.

11. The system of claim 10, wherein the network is the Internet.

12. The system of claim 10, wherein a Personal Digital Assistant having a wireless modem includes the data input, display monitor, and control interface for wirelessly communicating with a server via the network.

13. The system of claim 12, wherein a control network is coupled between the server and the equipment.

14. The system of claim 10, further comprising software for associating a region of the image with a command for control of the equipment upon the user-interaction with the control interface.

15. A remote control device for remotely controlling an apparatus, the device comprising:
a control interface for associating a video image of the apparatus with a command for control of the apparatus via a control network upon a user-interaction with the control interface.

16. The device of claim 15, wherein the video image of the apparatus is obtained by a video camera and transmitted to the control interface via network coupled to the control network.

17. The device of claim 16, wherein the network is the Internet.

18. The device of claim 1, wherein the control interface comprises a touch screen.

19. The device of claim 15, wherein the control interface comprises a computer mouse.

20. The device of claim 15, wherein the control interface comprises controls for controlling the camera.
